(19) United States
(12) Patent Application Publication
(10) Pub. No.: US 2015/0360858 A1
(43) Pub. Date: Dec. 17, 2015

(54) TANK LOCKING SYSTEM AND METHOD

(71) Applicant: Bruce Jacob Elson, Palm Springs, CA (US)

(72) Inventor: Bruce Jacob Elson, Palm Springs, CA (US)

(21) Appl. No.: 14/302,305

(22) Filed: Jun. 11, 2014

(51) Int. Cl. B65D 90/22; E05B 73/00

(52) U.S. Cl. CPC B65D 90/22; E05B 73/00

(57) ABSTRACT

A lock system secures a clamp to a tank port for sealing a tube connection on a tank. The lock system includes a plurality of lock components that detachably mate to engage with, and inhibit tampering of the clamp. The internal lock components are disposed in, and share a common longitudinal axis with an exterior case. The exterior case forms a protective barrier that restricts access to both the internal lock components and the clamp. A key lock serves to couple the exterior case to the internal lock components. The internal components consist of a female lock that couples to the key lock, serving as a bridge that secures the exterior case to the clamp. A nut serves to couple an opposite end of the female lock to the clamp. A wrench can rotate the nut for creating a tighter lock between the clamp and the internal lock components.

### FIELD OF THE INVENTION

The present invention relates generally to a lock system. More so, the lock system provides an interconnection of locks that are covered by a protective exterior case to secure a clamp to a tank port.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a lock is a mechanical or electronic fastening device that is released by a physical object, such as a key, keycard, fingerprint, RFID card, or security token, by supplying secret information. The information may include, perforations on a key blade, a key code, or password.

Typically, a storage tank is a container, usually for holding liquids and gases. Storage tanks are often cylindrical in shape, perpendicular to the ground with flat bottoms, and a fixed or floating roof. There are usually many environmental regulations applied to the design and operation of storage tanks, often depending on the nature of the fluid contained within.

In many cases, storage tanks include apertures for receiving connecting tubes. The 1 tubes can be operable to allow the fluid to flow in or out of the tank, A clamp holds a seal onto the aperture. A clamp bolt extends from the clamp, and may be secured in a closed position with a wing nut type fastener. The wing nut is easily removed by rotating against the clamp bolt.

Often, the aperture provides a point on the tank for accessing the internal fluid. Yet, this access is often undesirable, so a key may be utilized to restrict access. The key is an instrument that is used to operate a lock on the clamp. A key is usually intended to operate one specific lock or a small number of locks that are keyed alike, so each lock requires a unique key.

Typically, vandalism is the behavior of ruthless destruction or spoiling of anything beautiful or venerable. The term also includes criminal damage such as graffiti and defacement directed towards any property without permission of the owner. Tanks provide attractive targets for vandalism since they are often unguarded and may contain valuable liquids.

Even though the above cited locking systems address some of the needs of the market, a locking system for restricting tampering to a clamp that seals a tank port is still desired. Thus, to meet this long felt need, the inventor has invented a lock system for ports on stainless steel tanks as used in the wind industry. As mentioned previously, there is a real need to secure ports on wine tanks, both to prevent theft and contamination. One the average steel port on a tank used in the wine industry, there are several ports with three different sizes of clamps. Each tank as three doors: two on the sides and one on the top of the tank and a tasting valve. All of the clamps currently in use take a stainless steel wing nut that does not lock, thereby opening the door for vandalism and theft. In the prior art there are locks that effectively protect one size of clamp, but the current invention protects all three sizes of clamps.

### SUMMARY OF THE INVENTION

This invention is directed to a lock system that secures a clamp to a tank port for sealing a tube connection on a tank. The lock system includes a plurality of internal lock components that detachably mate to engage with, and inhibit tampering of the clamp. At least one internal lock component is disposed in, and shares a common longitudinal axis with an exterior case. The exterior case forms a protective barrier that restricts access to both the at least one internal lock component and the clamp. A key lock serves to couple the exterior case to the at least one internal lock component. The at least one internal component consists of a female lock that couples to the key lock, serving as a bridge that secures the exterior case to the clamp. A nut member serves to couple an opposite end of the female lock to the clamp. A wrench can rotate the nut member for creating a tighter lock between the clamp and the at least one internal lock component.

In one embodiment of the present invention, the lock system includes at least one internal lock component comprised of a plurality of components that detachably mate to engage with. and inhibit tampering of the clamp. The at least one internal lock component is disposed in, and shares a common longitudinal axis with an exterior case. The exterior case forms a protective barrier that restricts access to both the at least one internal lock component and the clamp. A key lock serves to couple the exterior case to the at least one internal lock component.

In one embodiment of the present invention, the exterior case includes a cylindrical shape configured to at least partially cover the at least one internal lock component and the clamp. In this manner, the at least one internal lock component is protected from undesired tampering. The exterior case includes a case clamp end for at least partially covering the clamp. The case clamp end includes at least one notch configured to allow a section of the clamp to at least partially pass through the exterior case. The exterior case further includes a case key end configured to regulate access to the at least one internal lock component. The at least one internal lock component passes through the case key end and rests on a case outer surface. The case key end further comprises a case interior surface that rotatably couples to the at least one internal lock component. The case interior surface includes˜case threaded section that helps strengthen the attachment between the at least one internal lock component and the case interior surface.

In one embodiment of the present invention, the at least one internal lock component includes a key lock configured to join the exterior case to the at least one internal lock component. The key lock is operable to at least partially extend through the case key end and thereby, rotatably engage the case threaded section. In some embodiments, the key lock includes a keyway end configured to receive a key. The key is configured to engage the keyway end for coupling and uncoupling the key lock to the exterior case. The key lock rotates in response to rotation of the key in the keyway end, and the key lock moves longitudinally, relative to the exterior case, in response to rotation of the key. In this manner, the exterior case may couple to the at least one internal lock component, which in turn, couples to the clamp. This chain of couplings, all protected by the exterior case, provides the locking functionality of the present invention. In some embodiments, the keyway end may be flanged to rest on a perimeter of the case key end. In this manner the key lock is restricted from longitudinal movements while in a locked position.

In some embodiments, the key lock includes a key lock mounting end for engaging the case key end. The key lock mounting end extends through a female section of the case interior surface to rotatably engage the case threaded section. In this manner the key lock is operable to detach from the exterior case in response to rotation of the key in a first direction. Conversely, the key lock is operable to couple to the at least one internal lock component in response to rotation of the key in a second direction. The key lock mounting end forms a snug fit when positioned within the case key end.

In some embodiments, rotation of the key in a first direction urges the key lock. along a longitudinal axis, into engagement with the case key end. A key lock rod extends from the key lock mounting end. The key lock rod may be threaded to rotatably engage, and couple to additional components of the at least one internal lock component.

In one embodiment of the present invention, the at least one internal lock component comprises a female lock that simultaneously couples the clamp to the key lock. The female lock is disposed to position between the clamp and the key lock, thereby forming a bridge that secures the exterior case to the clamp. The female lock includes a female lock channel that passes along a longitudinal axis, and through the interior of the female lock.

In some embodiments, the female lock comprises a female key end, which is threaded and configured to receive the key lock rod that extends from the key lock mounting end. In this manner, rotation of the key lock in a first direction urges the key lock rod into engagement with the female key end. This results in the female lock coupling to the key lock.

In some embodiments, the female lock includes a female clamp end for engaging the clamp. The female clamp end may include a socket having hexagonal dimensions, such as an Allen screw socket, positioned in a central area of the female lock channel. The socket is operable to be rotated in a second direction to urge the female lock into a secure engagement with the key lock. Those skilled in the art will recognize that the clamp may include a clamp bolt that presses a pair of clamps together. The clamp bolt may be threaded, and extends through the female lock channel In this manner, rotating the female lock in a second direction urges the clamp bolt through the female clamp end, thereby tightening the clamp onto the tank port. The female lock may then couple to the clamp at a desired tightness.

In one alternative embodiment, a nut member positions between the clamp and the female lock to provide a surface that is efficacious for tightening the female lock onto the key lock with a tool, such as a wrench. This wrench tightening serves to enhance the locking function of the lock system. A nut channel, which may be threaded, passes through the nut member. The clamp bolt may pass through both the nut channel and the female lock channel simultaneously. The nut member includes a nut end that is configured to be rotated by a tool, such as a wrench, for additional torque while tightening or loosening the at least one internal lock component from the clamp. The additional torque created by rotating the nut member creates additional security for locking the at least one internal lock component to the clamp. The nut member also includes a nut female end configured to mate with the female clamp end. In one embodiment, the nut female end includes a cone shaped protrusion adapted to interlock with a similar cone shaped depression in the female clamp end. In this manner, rotation of the nut member in a first direction locks the nut female end to the clamp.

A first aspect of the present invention provides a lock system comprising: an exterior case for at least partially covering at least one internal lock component and a clamp, the exterior case comprising a case clamp end for at least partially covering a clamp, the case clamp end comprising at least one notch configured to allow a section of the clamp to at least partially pass through the exterior case, the exterior case further comprising a case key end, the case key end being configured to couple to the at least one internal lock component, the case key end comprising a case interior surface for engaging the at least one internal lock component, the case interior surface comprising a case threaded section for strengthening the attachment between the at least one internal lock component and the case interior surface; a key lock for joining the exterior case to the at least one internal lock component, the key lock being operable to at least partially extend through the case key end and engage the case threaded section, the key lock comprising a keyway end, the keyway end being configured to receive a key, the keyway end comprising a flange for resting on a perimeter of the case key end, wherein the key lock is operable to detach from the exterior case in response to rotation of the key in a first direction, the key lock is further operable to couple to the at least one internal lock component in response to rotation of the key in a second direction, the key lock further comprising a key lock mounting end for at least partially passing through the case key end and engaging the at least one internal lock component, the key lock mounting end comprising a key lock rod, the key lock rod being configured to extend through the case interior surface; a female lock for joining the clamp to the key lock, the female lock comprising a female lock channel, the female lock channel being disposed to pass along a longitudinal axis of the female lock, the female lock channel comprising a female key end, the female key end being configured to at least partially receive the key lock rod, wherein rotation of the key lock in a first direction urges the key lock rod into engagement with the female key end, the female lock further comprising a female clamp end, the female clamp end being configured to engage the clamp, the female clamp end being operable rotate in a second direction for urging the female lock into a secure engagement with the key lock; and a nut member for enhancing the connection between the female lock and the key lock, the nut member comprising a nut channel, the nut channel being configured to at least partially receive a clamp bolt from the clamp, wherein the clamp bolt is disposed to pass through the nut channel and the female lock channel, the nut member further comprising a nut end, the nut end being configured to be rotated in the first direction to urge the female lock into engagement with the clamp, the nut member further comprising a nut female end, the nut female end being configured to mate with the female clamp end.

In a second aspect, the lock system includes an exterior case that inhibits tampering of the at least one internal lock component and the clamp.

In another aspect, the tank includes vats, containers, and fluid transfer tubes.

In another aspect, the exterior case is a stainless steel cylinder dimensioned 3⅓″ long and having a diameter of 1 W′.

In another aspect, the key lock rod is a threaded rod.

In yet another aspect, the key is rotatable to lock and unlock the key lock mounting end from the female key end, and thereby the exterior case, depending on the direction of the rotation.

In another aspect, in operation, the clamp orientation would be determined on the tank. The clamp is secured around the tank port by closing the clamp around the port to form a clamp rod, thereby providing a threaded rod disposed to pass through the at least one internal component of the lock system. The clamp bolt extends from the clamp, whereby locking the clamp bolt secures the clamp around the tank port. In one embodiment, an initial Step comprises orienting the clamp bolt to face a nut end. The lock system is oriented such that the nut end of the nut faces the end of the clamp bolt. In some embodiments, a Step includes passing the key lock through an exterior case. In this manner, the exterior case indirectly secures to the clamp through the at least one internal lock component. The keyway end is operable to lock and unlock in response to a key. The key lock mounting end is threaded and rotatably engages a case interior surface.

In some embodiments, the method may then proceed to a Step of joining the nut to the female lock. The nut female end is configured to be rotatable by a wrench in a second direction to mate with the female clamp end. Rotating the nut end tightens the clamp bolt and the at least one internal component connections. The nut female end may include a cone shaped protrusion configured to engage a similarly shaped cone shaped depression in the female clamp end. A next Step includes addressing the opposite side of the female lock by joining the female lock to a key lock. The female key end is threaded and rotatably engages the key lock mounting end. The key serves to lock and unlock this connection. A Step of moving the clamp rod through the nut channel provides the initial connection between the clamp and the lock system. A Step of moving the clamp rod through a female lock channel continues the tightening of the clamp to the lock system. A next Step includes rotating a key in the first direction. The key is operable to release the key lock rod form the similarly threaded female key end. The method may then include a Step of rotating a nut end in a second direction. The nut end can be rotated in the second direction to bring the threads together for the clamp rod and the female lock. A [mal Step includes locking the clamp around the tank port. The exterior case protects against tampering, and the at least one internal lock component joins the exterior case to the clamp. In this manner, tampering with the tank port may be inhibited.

One benefit of the lock system is that it provides greater flexibility in sealing an eclectic assortment of tanks and tank ports that utilize the clamp and clamp bolt locking style.

Another benefit is that the lock system helps protect against vandalism, theft, accidents, and contamination.

Yet another benefit is that the lock system does not require expensive electrical components or labor intensive moving parts.

These and other advantages of the invention will be further understood and appreciated by those skilled in the art by reference to the following written specification, claims and appended drawings.

### BRIEF DESCRIPTION OF THE DRAWINGS

The invention will now be described, by way of example, with reference to the accompanying drawings, in which:

FIG. 1 illustrates detailed perspective views of a lock system joined with a clamp, in accordance with an embodiment of the present invention;

FIG. 2 illustrates a side view showing the clamp portion removed from the sleeve portion, in accordance with an embodiment of the present invention;

FIG. 3 illustrates detailed perspective views of at least one internal lockcomponent, in accordance with an embodiment of the present invention;

FIG. 4 illustrate a top view of a female lock and a nut member, in accordance with an embodiment of the present invention; and,

FIG. 5 illustrates a flowchart diagram of a method for locking a clamp, in accordance with an embodiment of the present invention.

Like reference numerals refer to like parts throughout the various views of the Detailed Description of the Invention

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in the figures.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

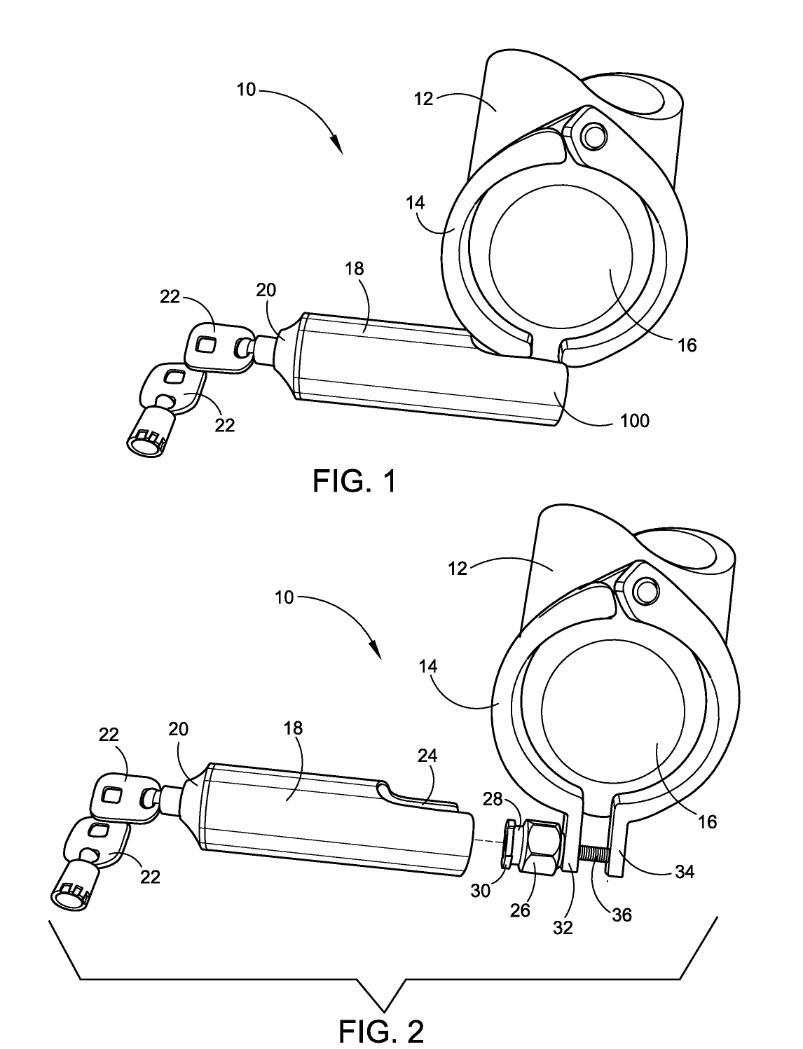

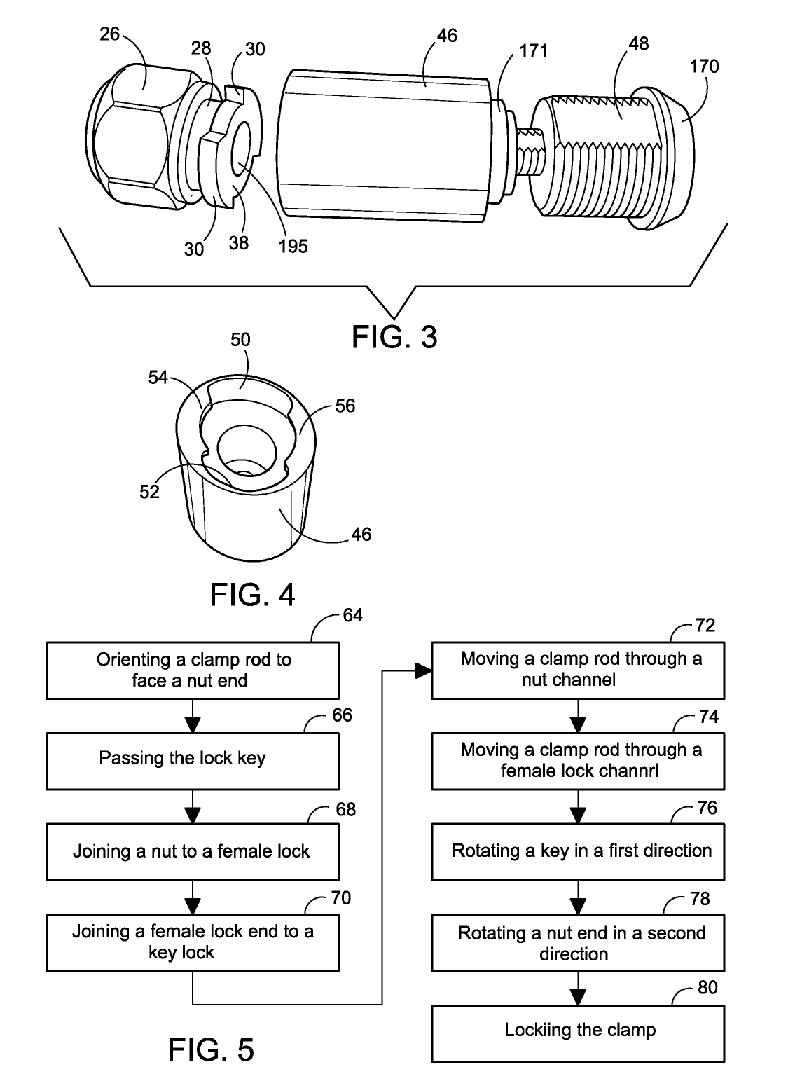

A lock system is described in FIGS. 1 through 4. The lock system 10 secures a tank port for helping to restrict tampering and contamination of a tank. Specifically, the lock system is an assembly that secures a clamp 14 to a tank port 16 for sealing a tube connection 12 on the tank. In some embodiments, the lock system includes at least one internal lock component comprised of a plurality of components that detachably mate to engage with, and inhibit tampering of the clamp (an exploded view of which can be found in FIG. 3). The at least one internal lock component is disposed in, and shares a common longitudinal axis with an exterior case 18. The exterior case forms a protective barrier that restricts access to both the at least one internal lock component and the clamp. A key lock 20 serves to couple the exterior case 18 to the at least one internal lock component. Suitable materials for fabricating the lock system may include, without limitation, stainless steel, metal alloys, brass, iron, aluminum, wood, and high density polymers. Additionally, the lock system may comprise myriad shapes including, without limitation, a cylinder shape, a rectangle shape, a pyramid shape, and an oval shape.

In one embodiment of the present invention, the exterior case 18 includes a cylindrical shape configured to at least partially cover the at least one internal lock component and the clamp 14, as referenced in FIGS. 1 and 2. In this manner, the at least one internal lock component is protected from undesired tampering. The exterior 18 includes a case clamp end 100 for at least partially covering the clamp 14. The case clamp end 100 includes at least one notch 24 configured to allow a section of the clamp to at least partially pass through the exterior case 18. The exterior case 25 further includes a case key end 35 configured to regulate access to the at least one internal lock component. The at least one internal lock component passes through the case key end 20 on one end, and couples to the clamp on the other end, thereby forming a bridge between the exterior case 18 and the clamp 14. The case key end 20 further comprises a case interior surface 52 that rotatably couples to the at least one internal lock component 54. The case interior surface 52 includes a case threaded section that helps strengthen the attachment between the at least one internal lock component 54 and the case interior surface 52. In one embodiment, the exterior case 25 includes a specially machined stainless steel cylinder lock 3⅓″ long and having a diameter of 1 W′. However, in other embodiments, the exterior case 18 may be sized and dimensioned larger or smaller, depending on the parameters of the clamp and the tank port.

As referenced in FIG. 3, the at least one internal lock component includes a key lock configured to join the exterior case 18 with the at least one internal lock component. The key lock is operable to at least partially extend through the case key end 20 and thereby, rotatably engage the case threaded section. The key lock includes a keyway end, which is a typical female part of a key/lock combination, configured to receive a key 22. The key 22 is configured to engage the keyway end for coupling and uncoupling the key lock to the exterior case 18. For example, without limitation, the keyway end may include an internal mechanism comprising of a pack of flat levers that are raised to different heights by the key 22, whereupon slots on the levers line up and permit a bolt to move back and forth, opening or closing the key lock. The key lock rotates in response to rotation of the key 22 in the keyway end, and the key lock moves longitudinally, relative to the exterior case 18, in response to rotation of the key 22. In this manner, the exterior case 18 may couple to the at least one internal lock component, which in turn, couples to the clamp 14. This chain of couplings, all protected by the exterior case 18, provides the locking functionality of the present invention. The keyway end may include the flange 170 that rests on a perimeter of the case key end 20. In this manner the key lock is restricted from longitudinal movements while in a locked position. Those skilled in the art, in light of the present teachings, will recognize that the key 22 may include, without limitation, a specially cut metal instrument, a keypad, a magnetic strip, and a fingerprint reading device.

The key lock includes a key lock mounting end 49 for engaging the case key end 20. The key lock mounting end 48 extends through a female section of the case interior surface to rotatably engage the case threaded section. In this manner the key lock is operable to detach from the exterior case 18 in response to rotation of the key 22 in a first direction. Conversely, the key lock is operable to couple to the at least one internal lock component in response to rotation of the key 22 in a second direction. In some embodiments, rotation of the key 22 in a first direction urges the key lock, along a longitudinal axis, into engagement with the case key end 20. In some embodiments, the key lock rod 36 extends from the key lock mounting end 100. The key lock rod 36 may be threaded to rotatably engage, and couple to additional components of the at least one internal lock component. The key lock mounting end 100 forms a snug fit when positioned within the case key end 20.

In one embodiment of the present invention, the at least one internal lock component comprises a female lock (FIG. 4) that simultaneously couples the clamp to the key lock, which is the female of the typical key/lock combination located at the case key end 20. The female lock 46 is disposed to position between the clamp and the key lock, thereby forming a bridge that secures the exterior case 18 to the clamp. The female lock 46 includes a female lock channel that passes along a longitudinal axis, and through the interior of the female lock 46. The female lock 46 may be sized and dimensioned to include a 1 W′ cylindrical stainless steel lock. However, in other embodiments, the exterior case 18 may be sized and dimensioned larger or smaller, depending on the parameters of the clamp 14 and the tank port 16.

In some embodiments, the female lock 46 comprises a female key end 100, which is threaded and configured to receive the key lock rod 75 that extends from the key lock mounting end 60. In this manner, rotation of the key lock 45 in a first direction urges the key lock rod 75 into engagement with the female key end 171. In this manner, the female lock 65 couples to the key lock.

In some embodiments, the female lock 46 includes a female clamp end 120 for engaging the clamp 10. The female clamp end 52 may include a socket having hexagonal dimensions, such as an Allen screw socket, positioned in a central area of the female lock channel. The socket is operable to be rotated in a second direction to urge the female lock 46 into a secure engagement with the key lock. Those skilled in the art will recognize that the clamp may include a clamp bolt that presses a pair of clamps 14 together. The clamp bolt may be threaded, and extends through the female lock channel, whereby rotating the female lock in a second direction urges the clamp bolt through the female clamp end, thereby tightening the clamp onto the tank port. The female lock may then couple to the clamp at a desired tightness.

In one alternative embodiment, a nut member 28 positions between the clamp 14 and the female lock 46 to provide a surface that is efficacious for tightening the female lock 46 onto the key lock with a tool, such as a wrench. This wrench tightening serves to enhance the locking function of the lock system. A nut channel 195, which may be threaded, passes through the nut member 28. The clamp bolt may pass through both the nut channel and the female lock channel simultaneously. The nut member includes a nut end 28 that is configured to be rotated by a tool, such as a wrench, for additional torque while tightening or loosening the at least one internal lock component 54 from the clamp. The additional torque created by rotating the nut member 28 creates additional security for locking the at least one internal lock component to the clamp. The nut member also includes a nut female end 30 configured to mate with the female clamp end 52. In one embodiment, the nut female end 30 includes a cone shaped protrusion adapted to interlock with a similar cone shaped depression in the female clamp end 52. In this manner, rotation of the nut member in a first direction locks the nut female end to the clamp.

Those skilled in the art, in light of the present teachings, will recognize that the clamp bolt, the nut member 28, and the female lock 46 form a tight fit because the mutual clamp bolt is under a constant tensile stress. The tensile stress pulls the nut threads against the bolt threads, and the nut face against the bearing surface, with a constant force, so that the nut member 28 cannot rotate without overcoming the friction between these surfaces. This tensile stress forms the chief locking mechanism for the lock system. The exterior case 18, of course, protects these internal lock components from tampering and accidents.

In some embodiments, the lock system is designed to secure the clamp 14 to the tank port 16 for sealing a tube connection on the tank. The lock system includes at least one internal lock component comprised of a plurality of components that detachably mate to engage with, and inhibit tampering of the clamp. The at least one internal lock component is disposed in, and shares a common longitudinal axis with an exterior case 18. The exterior case 18 forms a protective barrier that restricts access to both the at least one internal lock component and the clamp. A key lock serves to couple the exterior case 18 to the at least one internal lock component. A method (illustrated in FIG. 5) for locking a clamp with a lock system restricts access to the tank port. In operation, the method includes an initial determination of the orientation and positioning of the clamp 10 on the tank port.

In one alternative embodiment, the lock system may include its own clamp bolt and clamp that are configured to mate with a variety of tank ports. In yet another alternative embodiment, the lock system may include a sensor and an alert system for alerting to tampering, improper installation, and malfunctions. In yet another alternative embodiment, the keyway end utilizes a magnetic card, a fingerprint scanner, or voice recognition software for a key 22.

The method 600 may include an initial Step 64 of orienting the clamp bolt to face the nut end 26. The lock system is oriented such that the nut end 26 faces the end of the clamp bolt. In one embodiment, the clamp 14 is secured around the tank port 16 by closing the clamp around the tank port to form a clamp rod, thereby forming a single threaded rod that is disposed to pass through the at least one internal lock component. The clamp bolt extends from the clamp, whereby locking the clamp bolt secures the clamp around the tank port.

In some embodiments, a Step 66 includes passing the key lock through the exterior case, In this manner, the exterior case indirectly secures to the clamp through the at least one internallock component. The keyway end is operable to lock and unlock in response to the key. The key lock mounting end is threaded, and rotatably engages the case interior surface.

The method may then proceed to a Step 68 of joining the nut member to the female lock. The nut member is configured to be rotatable by a wrench in a second direction to tighten the connection with the clamp bolt and the the female clamp end. Rotating the nut end tightens the nut member to the clamp bolt and the at least one internal lock component. The nut female end may include a cone shaped protrusion configured to engage a similarly shaped cone shaped depression in the female clamp end.

A next Step 70 includes addressing the opposite side of the female lock by joining the female lock to a key lock. The female key end is threaded and rotatably engages the key lock mounting end. The key serves to lock and unlock this connection.

A Step 72 comprises moving the clamp rod through the nut channel provides the initial connection between the clamp and the lock system.

A Step 74 includes moving the clamp rod through the female lock channel. This passage of the clamp bolt continues the tightening of the clamp to the lock system.

A next Step 76 includes rotating the key in the first direction. The key is configured to engage the keyway end for coupling and uncoupling the key lock to the exterior case. Additionally, the key is operable to release the key lock rod from the similarly threaded female key end. Those skilled in the art will recognize that the key and the key lock may include a commercially cylinder lock and key available in a hardware store.

The method may then include a Step 78 of rotating the nut end in a second direction. The nut end can be rotated in the second direction to bring the threads together for the clamp rod and the female lock.

A final Step 80 includes locking the clamp around the tank port. The exterior case protects against tampering, and the at least one internal lock component joins the exterior case to the clamp. In this manner, tampering with the tank port may be inhibited.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A lock system for locking a clamp on a tank port, the lock system comprising: an exterior case for at least partially covering the clamp and at least one internal lock component, the exterior case comprising a case clamp end for at least partially covering the clamp and a clamp bolt, the exterior case further comprising a case key end for regulating access to the at least one internal lock component, the case key end comprising a case interior surface for engaging the at least one internal lock component;
a key lock for joining the exterior case to the at least one internal lock component, the key lock being operable to at least partially extend through the case key end, the key lock comprising a keyway end, the keyway end being configured to receive a key,
wherein the key lock is operable to detach from the exterior case in response to rotation of the key in a first direction, the key lock is further operable to couple to the at least one internal lock component in response to rotation of the key in a second direction,
the key lock further comprising a key lock mounting end for at least partially passing through the case key end and engaging the at least one internal lock component, the key lock mounting end comprising a key lock rod; and
a female lock for joining the clamp to the key lock, the female lock comprising a female lock channel, the female lock channel being disposed to pass along a longitudinal axis of the female lock, the female lock channel comprising a female key end, the female key end being configured to at least partially receive the key lock rod,
wherein rotation of the key lock in a first direction urges the key lock rod into engagement with the female key end,
the female lock further comprising a female clamp end, the female clamp end being configure to engage the clamp, the female clamp end being operable rotate in a second direction for urging the female lock into a secure engagement with the key lock.

2. The lock system of claim 1, where the lock system comprises a tank lock.

3. The lock system of claim 1, where the lock system comprises stainless steel.

4. The lock system of claim 1, wherein the case clamp end comprises at least one notch configured to allow a section of the clamp to at least partially pass through the exterior case.

5. The lock system of claim 1, wherein, the case interior surface comprises a case threaded section for rotatably mating the key lock mounting end with the case interior surface.

6. The lock system of claim 5, wherein the key lock mounting end is operable to at least partially extend through the case key end and engage the case threaded section.

7. The lock system of claim 1, wherein the keyway end comprises a flange for resting on a perimeter of the case key end.

8. The lock system of claim 1, wherein the key lock rod is configured to extend through the case interior surface.

9. The lock system of claim 1, wherein the key lock mounting end comprises a threaded key lock rod.

10. The lock system of claim 9, wherein the key lock rod is operable to rotatably engage the female key end for securing a connection between the key lock and the female lock.

11. A lock system for locking a clamp on a tank port, the lock system consisting of: an exterior case for at least partially covering a clamp and at least one internal lock component, the exterior case comprising a case clamp end for at least partially covering the clamp and a clamp bolt, the case clamp end comprising at least one notch configured to allow a section of the clamp to at least partially pass through the exterior case, the exterior case further comprising a case key end, the case key end being configured to regulate access to the at least one internal lock component, the case key end comprising a case interior surface for engaging the at least one internal lock component, the case interior surface comprising a case threaded section for strengthening the attachment between the at least one internal lock component and the case interior surface; a key lock for joining the exterior case to the at least one internal lock component, the key lock being operable to at least partially extend through the case key end and engage the case threaded section, the key lock comprising a keyway end, the keyway end being configured to receive a key, the keyway end comprising a flange for resting on a perimeter of the case key end, wherein the key lock is operable to detach from the exterior case in response to rotation of the key in a first direction, the key lock is further operable to couple to the at least one internal lock component in response to rotation of the key in a second direction, the key lock further comprising a key lock mounting end for at least partially passing through the case key end and engaging the at least one internal lock component, the key lock mounting end comprising a key lock rod, the key lock rod being configured to extend through the case interior surface; a female lock for joining the clamp to the key lock, the female lock comprising a female lock channel, the female lock channel being disposed to pass along a longitudinal axis of the female lock, the female lock channel comprising a female key end, the female key end being configured to at least partially receive the key lock rod, wherein rotation of the key lock in a first direction urges the key lock rod into engagement with the female key end, the female lock further comprising a female clamp end, the female clamp end being configured to engage the clamp, the female clamp end being operable rotate in a second direction for urging the female lock into a secure engagement with the key lock; and a nut member for enhancing the connection between the female lock and the key lock, the nut member comprising a nut channel, the nut channel being configured to at least partially receive a clamp bolt from the clamp, wherein the clamp bolt is disposed to pass through the nut channel and the female lock channel, the nut member further comprising a nut end, the nut end being configured to be rotated in the first direction to urge the female lock into engagement with the clamp, the nut member further comprising a nut female end, the nut female end being configured to mate with the female clamp end.
